(19) United States
(12) Patent Application Publication
(10) Pub. No.: US 2023/0238632 A1
(43) Pub. Date: Jul. 27, 2023

(54) ENERGY STORAGE SYSTEM

(71) Applicant: CARL FREUDENBERG KG, Weinheim (DE)

(72) Inventors: Peter Kritzer, Forst (DE); Fabian Hellweg, Weinheim (DE); Sascha Moeller, Buerstadt (DE); Tim Leichner, Moerstadt (DE)

(21) Appl. No.: 18/009,339

(22) PCT Filed: Jun. 8, 2021
(86) PCT No.: PCT/EP2021/065220

§ 371 Date: Dec. 9, 2022

(30) Foreign Application Priority Data
Jun. 10, 2020 (DE) 10 2020 115 396.1

(51) Int. Cl. H01M 50/202; H01M 10/613; H01M 10/6556

(52) U.S. Cl. CPC H01M 50/202; H01M 10/613; H01M 10/6556

(57) ABSTRACT

An energy storage system, including a housing in which a plurality of battery cells are arranged. The plurality of battery cells are spaced with respect to each other by a device arranged between every two respective adjacent battery cells of the plurality of battery cells, so that a space is created therein. At least one emergency cooling channel is associated with the space.

### CROSS-REFERENCE TO PRIOR APPLICATION

This application is a U.S. National Phase application under 35 U.S.C. § 371 of International Application No. PCT/EP2021/065220, filed on Jun. 8, 2021, and claims benefit to German Patent Application No. DE 10 2020 115 396.1, filed on Jun. 10, 2020. The International Application was published in German on Dec. 16, 2021 as WO 2021/249971 A1 under PCT Article 21(2).

### FIELD

The invention relates to an energy storage system, comprising a housing in which a plurality of battery cells are arranged, wherein the battery cells are spaced from each other by means of a device arranged between two respective adjacent battery cells in such a manner that a space is created.

### BACKGROUND

Energy storage systems, in particular rechargeable storage batteries for electrical energy, are widely used in mobile systems, in particular. Rechargeable storage batteries for electrical energy are used, for example, in portable electronic devices, such as smartphones or laptop computers. Furthermore, rechargeable storage batteries for electrical energy are increasingly used for providing energy to electrically powered vehicles. A great variety of electrically powered vehicles is conceivable, such as bicycles, vans or trucks as well as cars. Applications in robots, ships, aircraft and mobile working machines are also conceivable. Further fields of use of electrical energy storage systems are stationary applications, such as in backup systems, in grid stabilization systems and for the storage of electrical energy from renewable energy sources.

A frequently used energy storage system is a rechargeable storage battery in the form of a lithium-ion battery. Lithium-ion batteries, just like other rechargeable storage batteries for electrical energy, mostly include a plurality of battery cells, which are installed in a common housing. Generally, a plurality of joined battery cells are combined to a module.

The energy storage system does not only refer to lithium-ion batteries. Other rechargeable battery systems, such as lithium-sulfur batteries, solid-state batteries, or metal-air electrochemical cells are conceivable energy storage systems. Furthermore, supercapacitors are also possible energy storage systems.

Energy storage systems in the form of rechargeable storage batteries have the highest electrical storage capacity and the best power intake and output only for a limited temperature spectrum. At temperatures above or below the optimum operating temperature range, the storing capacity, the power intake capacity and the power output capacity of the storage battery are substantially reduced and the functionality of the storage battery is negatively affected. Also, excessive temperatures can irreparably damage the storage battery. Continued exposure to high temperatures as well as short temperature peaks should be avoided at all cost. For lithium-ion batteries, for example, prolonged exposure to temperatures higher than 50° C. and short temperature peaks of more than 80° C. should not be exceeded.

In applications in cars, in particular, fast charging capability of the energy storage systems is desirable. The storage batteries forming an energy storage system are to be charged completely or almost completely within a short period of time, such as within 15 minutes. Due to the efficiency of the charging system of about 90% to 95%, large amounts of heat are emitted during the charging process, which have to be dissipated from the energy storage system. This amount of heat is not emitted in the normal mode of operation. It is therefore necessary to design the cooling system of the energy storage system in such a manner that the amount of heat arising during the charging process can be absorbed.

Excessive temperatures can lead to irreparable damage of the energy storage system. In this context, so-called thermal runaway is known, in particular, with lithium-ion cells. Herein, large amounts of thermal energy and gaseous decomposition products are released resulting in high pressures and high temperatures in the battery cell, or in the housing in which the battery cell is arranged. This effect is problematic, in particular, in energy storage systems having high energy density, as it is necessary, for example, to provide electrical energy in electrically powered vehicles. Due to increasing amounts of energy of the individual cells and the increase in the packing density of the cells arranged within the housing, the problem of thermal runaway is exacerbated.

Furthermore, thermal runaway of an individual cell can be triggered by a multitude of other mechanisms. These are, for example, cell-external shorts, cell-internal shorts, crash events during which the cell housing is damaged, or improper overcharging of the battery cell. Given the great number of possible damage events alone, thermal runaway of individual battery cells cannot be completely ruled out.

In the vicinity of a runaway cell, temperatures in the range of 600° C. can occur at the housing sidewall of the cell over a duration of about 30 seconds. The higher the energy density in the battery cell the higher the thermal load. The device arranged between the battery cells must be able to withstand such thermal loads and reduce energy transfer to adjacent cells in such a way that the thermal load on the adjacent cell is only at most 150° C. It is important to limit the energy transfer to the adjacent cells to prevent them from also thermally running away (also known as “Thermal Propagation”).

Due to the great number of possible damage events and the increase in the energy density both on the level of individual battery cells and on the level of entire energy storing systems, the risk of “Thermal Propagation” is hugely increased. When such “Thermal Propagation” takes place, it is not only the energy amount of an individual battery cell but the energy amount of the entire energy storage system that is released, which can involve an explosive damage event.

### SUMMARY

In an embodiment, the present disclosure provides an energy storage system, comprising a housing in which a plurality of battery cells are arranged, wherein the plurality of battery cells are spaced with respect to each other by a device arranged between every two respective adjacent battery cells of the plurality of battery cells, so that a space is created therein, wherein at least one emergency cooling channel is associated with the space.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates an energy storage system;

FIG. 2 schematically illustrates an energy storage system in a plan view;

FIG. 3 schematically illustrates an energy storage system in a plan view;

FIG. 4 schematically illustrates an energy storage system according to an embodiment;

FIG. 5 schematically illustrates an energy storage system according to an embodiment;

FIG. 6 schematically illustrates an energy storage system according to an embodiment;

FIG. 7 schematically illustrates various embodiments of devices;

FIG. 8 schematically illustrates various embodiments of closure elements;

FIG. 9 schematically illustrates a battery cell in the event of damage; and

FIG. 10 schematically illustrates an energy storage system comprising additional control mechanisms.

### DETAILED DESCRIPTION

In an embodiment, the present invention provides an energy storage system in which the risk of propagation to the overall system is reduced during thermal runaway of a battery cell.

In an embodiment, at least one emergency cooling channel is provided and associated with the space which is formed by the device arranged between two adjacent battery cells.

It is thus possible, in the event of damage, to conduct a cooling medium through the space between two adjacent battery cells. In the process, the cooling medium absorbs the heat which is released by a damaged battery cell. It is conceivable, in particular, for the cooling medium to evaporate, wherein the cooling medium is able to absorb a particularly large amount of heat due to the phase transition (evaporation enthalpy). The emergency cooling channel is thus not part of the regular cooling apparatus of the energy storage system. There is a flow through the emergency cooling channel only in the damage event, when a battery cell adjacent to the emergency cooling channel has been damaged.

The energy storage system thus preferably comprises a cooling apparatus comprising at least one cooling channel, wherein the cooling channel of the cooling apparatus is able to be brought into flow communication with the emergency cooling channel in the event of damage. The cooling apparatus is adapted to maintain the battery cells of the energy storage system within a desired temperature spectrum in the usual operating states. The cooling apparatus can thus also be adapted to cool the battery cells during a fast-charging process. Only in the event of damage, that is when a battery cell is irreparably damaged, a flow communication is established between a cooling channel of the cooling apparatus and the emergency cooling channel associated with a damaged battery cell, so that the cooling medium can be discharged from the cooling channel and can flow through the emergency cooling channel. In this case, the cooling medium can absorb large amounts of heat and prevent the battery cells adjacent to the damaged battery cell from being thermally overloaded and thus also thermally running away. To design an existing cooling system in such a way that it also caters for emergency cooling is advantageous because the emergency cooling can be implemented without additional weight and without additional cost.

The cooling channel can include at least one closure element, which opens in the damage event and establishes a flow-conducting communication between the cooling channel and the emergency cooling channel. In normal operation, the closure element closes off the cooling channel so that no cooling medium is lost. The closure element only opens in the damage event so that cooling medium can be discharged from the cooling channel and can flow through the emergency cooling channel. In the concrete case, the hot battery cell heats up the cooler thermally coupled to the battery cell and transfers the thermal energy to the closure element. The latter can open in a thermally initiated manner, for example by means of melting processes, thermal shrinkage or thermally induced actuators. A closure element which opens due to thermally induced actuators can comprise, for example, elements made of shape-memory alloys, or a chemical decomposition reaction can occur.

The closure element can be a separate component or can be formed from the cooling channel in an integral and one-piece configuration. For example, the closure element can be formed as a plug, which is either pressed into the cooling channel or pressed out of the cooling channel by a pressure increase. Alternatively, the closure element can be formed as a membrane or film which opens due to a local temperature application. Furthermore, the closure element can be implemented by a local reduction in the thickness of the cooling channel.

The closure element can be formed as a foil. The material of the foil can be, in particular, polymeric or metallic materials. The foil covers an emergency opening of the cooling channel.

At temperatures above a maximum operating temperature of the cooling apparatus, the closure element exposes the emergency opening. Herein, the closure element can melt, pivot, bend open or be chemically decomposed. In view of the operating temperature, the temperature at which the closure element exposes the emergency opening is between 80° C. and 400° C., preferably between 100° C. and 300° C. The lower the temperature for opening, the quicker the reaction in the event of damage. At lower opening temperatures, however, admissible temperature peaks, such as during fast charging, have to be taken into consideration.

Preferably, opening by the closure element is carried out as a function of temperature. It is advantageous, in particular, that no sensors or the like are needed at all. However, it is conceivable, as an alternative, to actively open the closure element. In this embodiment, a temperature sensor can output a signal to an actuator which then opens the closure element.

It is also conceivable to design the cooling circuit in such a manner that during opening of the closure element, the transport of cooling medium through the cooling apparatus is increased thus increasing the cooling performance of the emergency cooling. Blocking elements arranged inside the cooling apparatus are also conceivable. The blocking elements can be arranged, for example, in the interior of the cooling channel. They can be formed in such a manner that they block the cooling channel in the event of an emergency opening so that the cooling medium is forced to escape from the opened emergency opening.

The apparatus can include webs, which define at least one emergency cooling channel. The apparatus can be formed as a spacer so that, in normal operation, the battery cells have a predetermined distance from one another so that improved cooling is provided. Moreover, the predetermined distance between the battery cells allows unhindered swelling of the battery cells over their useful lives. By these means, the battery cells remain at a distance from each other over their entire useful lives. The webs can also help to adjust homogeneous pressing over the useful lives of the battery cells. The predetermined distance ensures that aged cells are not excessively compressed. Excessive compression would have deleterious consequences, in particular in view of the formation of destructive lithium dendrites during deep discharge processes or fast charging processes of aged battery cells.

According to a first embodiment, the sidewall of at least one emergency cooling channel can be formed by the housing sidewall of an adjacent battery cell. In this embodiment, in the event of damage, cooling medium will flow directly along the housing sidewall of the damaged battery cell. This causes a particularly good transfer of heat to the cooling medium.

According to a further embodiment, at least one emergency cooling channel is formed within the apparatus. Herein, it is advantageous that the apparatus can have a mechanically more rugged design. Preferably, the apparatus comprises at least two emergency cooling channels, wherein a first emergency cooling channel is associated with one adjacent battery cell and a second emergency cooling channel is associated with the other adjacent battery cell. In this embodiment, it is advantageous that the emergency cooling channel which is associated with the damaged battery cell can transport a cooling medium which evaporates within the emergency cooling channel and thus absorbs large amounts of heat. The emergency cooling channel associated with the other battery cell can receive a cooling medium which remains liquid, however. It is thus ensured that the temperature of the undamaged adjacent battery cell remains below the evaporating temperature of the cooling medium.

The apparatus can be of a plastic material, such as thermoplastics, thermosets or elastomers. Alternatively, it is conceivable for the apparatus to also consist of a metallic of ceramic material or to be formed of a material combination. It is also conceivable to design the apparatus at least in part of elastomeric materials. The apparatus is thus flexible and can function as a compression element for the battery cells. The embodiment of elastomers also has the advantage that the emergency cooling channel is laterally sealed and the transported medium can be discharged along the battery cell in a directed manner.

Preferably, the emergency cooling channel is in communication with the environment on the side facing away from the cooling channel. This ensures that evaporated cooling medium, in particular, can be easily discharged from the emergency cooling channel so that a heat transfer is provided. Also, the discharged cooling medium, after being discharged from the cooling channel, can be mixed with the gas flow discharged from the battery cell comprising hot decomposition products. On the one hand this substantially cools and, on the other hand, substantially dilutes the gas flow, both of which reduce the risk of fire or explosion of the hot gas flow emitted from the battery cell when aqueous cooling media are used

Embodiments of the energy storage system according to the present invention will be described in more detail in the following with reference to the drawing figures.

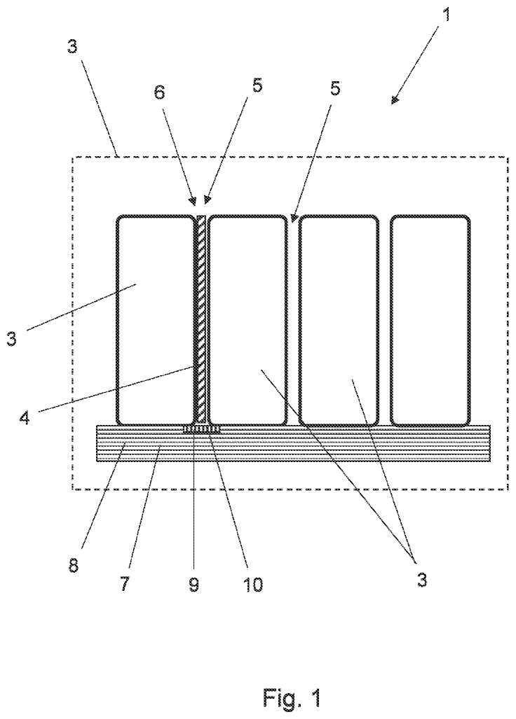

FIG. 1 shows an energy storage system 1, comprising a housing 2, in which a plurality of battery cells 3 are arranged. The battery cells 3, in the present embodiment, are formed as prismatic cells in the form of lithium-ion storage batteries and form components of the storage battery of an electric vehicle.

The battery cells 3 are spaced with respect to each other by means of a device 4 arranged between two adjacent battery cells 3 so that a space 5 is created between adjacent battery cells 3. In the view shown in FIG. 1, the device 4 is arranged, in an exemplary manner, only between two adjacent battery cells 3 for better illustration of the space 5.

The device 4 is formed in such a manner that an emergency cooling channel 6 is associated with the space 5. The energy storage system 1 comprises a cooling apparatus 7 comprising a cooling channel 8. The cooling channel 8 includes a closure element 9, which opens in the event of damage and establishes a flow-conducting communication between the cooling channel 8 and the emergency cooling channel 6.

The device 4 is formed of plastic material. A preferred material is silicone rubber (VMQ) or liquid silicone (LSR) due to its temperature resistance. Alternatively, the device 4 is formed of other temperature-resistant materials. In the region of the device 4, the cooling channel 8 is provided with a closure element 9, which covers an emergency opening 10 and thus seals off the cooling channel 8 in normal operation.

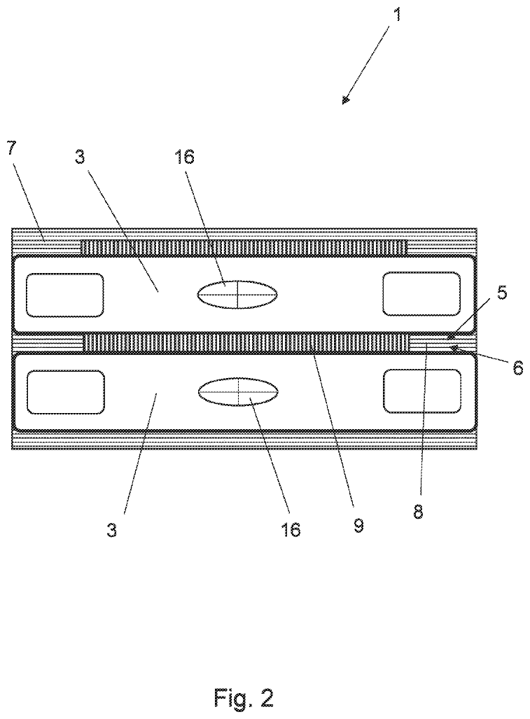

FIG. 2 shows the energy storage system 1 shown in FIG. 1 in a plan view. It can be seen that the battery cells are provided with a battery cell emergency opening 16 in the form of a bursting disc. The battery cell emergency opening 16 opens during thermal runaway due to thermal stress and/or compressive stress due to the decomposition processes occurring inside the battery cell 3. If the battery cells 3 exceeds a predetermined temperature and/or a predetermined pressure the battery cell emergency opening 16 opens and heated material is discharged from the interior of the battery cells 3.

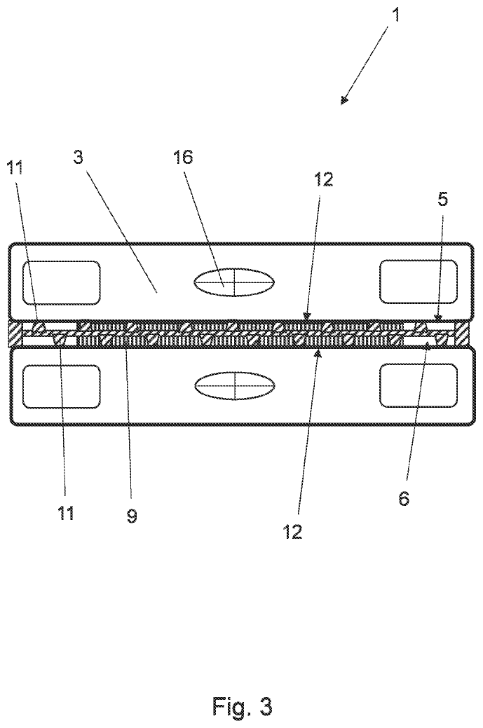

FIG. 3 shows the energy storage system 1 shown in FIG. 1 in a plan view. It can be seen that a device 4 is present between the battery cells 3 so that the adjacent battery cells 3 are spaced with respect to each other so that a space 5 is created. The device 4 includes webs 11, which define a plurality of emergency cooling channels 6. In this case, a sidewall of an emergency cooling channel 6 is formed by each housing sidewall 12 of an adjacent battery cell 3.

In the event of damage, the battery cell emergency opening 16 of a battery cell 3 opens, and heated, pressurized material is discharged from the interior of the battery cells 3. Under the effect of the material discharged from the battery cells 3 the closure element 9 exposes the emergency opening 10 so that cooling medium is discharged from the cooling channel 8. The latter flows through the emergency cooling channels 6. In the emergency cooling channels 6, which are directly associated with the damaged battery cell 3, the cooling medium evaporates and absorbs large quantities of heat due to the phase transition between liquid and gaseous states. However, cooling medium can flow through the emergency cooling channels 6, which are associated with the adjacent—undamaged—battery cell 3, without a phase transition occurring. In this battery cell 3, the cooling medium does thus not directly evaporate thus maintaining the surface temperature of the undamaged battery cell 3 below the boiling point of the cooling medium. This results in a two-stage protection mechanism overall. On the one hand, heat is absorbed by cooling medium evaporating at the damaged battery cell 3 and, on the other hand, the adjacent battery cell 3 is protected by liquid cooling medium.

The closure element 9 extends over the entire width of the device 4. Alternatively, the closure element 9 can extend only over a partial region.

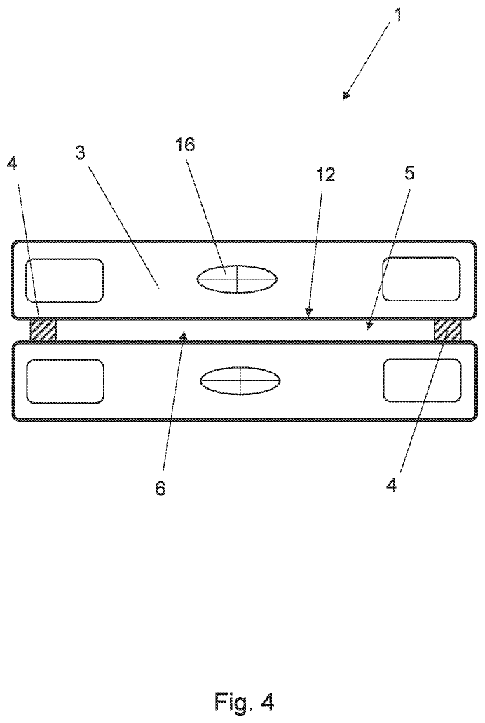

FIG. 4 shows an embodiment of the energy storage system 1 shown in FIG. 3. In the present embodiment, the device 4 only consists of frame-like spacers associated with the edge of the battery cells 3 and thus has a particularly simple configuration. In this embodiment, only a single emergency cooling channel 6 is formed. The present embodiment is particularly cost-effective. Furthermore, the structural space requirement is particularly small. The device 4 can be printed directly onto the battery cell 3.

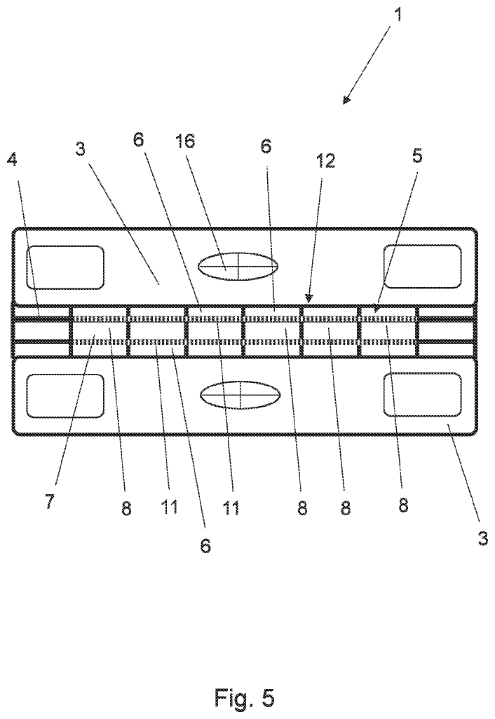

FIG. 5 shows a further embodiment of the energy storage system 1 shown in FIG. 3. In the present embodiment, the cooling channel 8 of the cooling apparatus 7 is in the space 5 between adjacent battery cells 3. The cooling channels 8 are separated from the emergency cooling channels 6 by webs 11. The webs 11 are formed in such a manner that they melt in the event of damage and establish a flow-conducting communication between the cooling channel 8 and the emergency cooling channel 6.

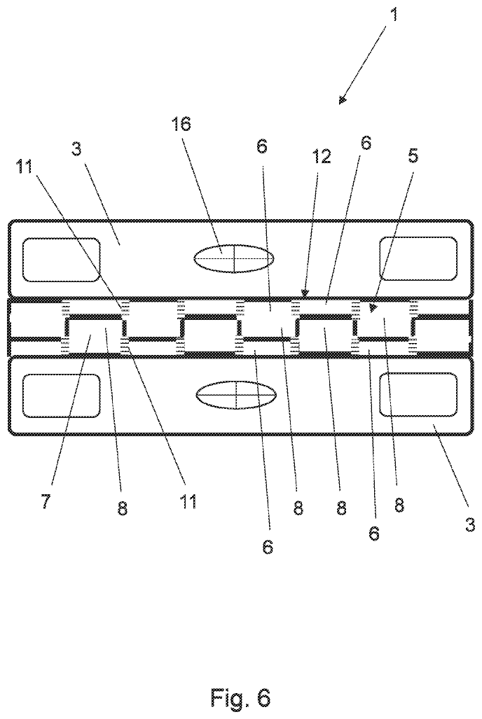

FIG. 6 shows a further development of the energy storage system 1 shown in FIG. 5. In the present embodiment, the cooling apparatus 7 is also arranged in the space 5 between two adjacent battery cells 3 and is formed of the device 4. In the present embodiment, cooling channels 8 are directly associated with battery cells 3, wherein an emergency cooling channel 6 is arranged within each cooling channel 8. The channels 6, 8 are separated from each other by means of webs 11, wherein the webs 11 form a closure element 9 in the region between cooling channel 8 and emergency channel 6. The closure element 9 is formed as a melting region which melts open in the event of damage and thus establishes a communication between cooling channel 8 and emergency cooling channel 6.

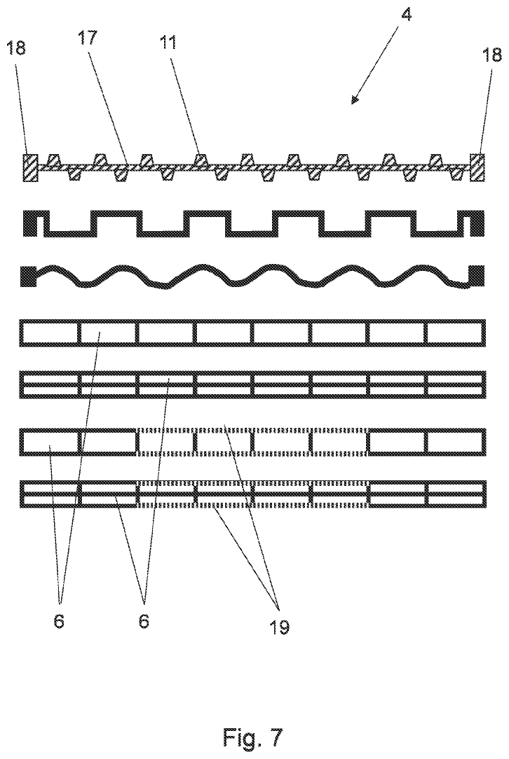

FIG. 7 shows various embodiments of a device 4, which is arranged between adjacent battery cells 3. In the top drawing, the device 4 comprises a central layer 17, which extends in parallel to the battery cells 3. Webs 11 are attached in a manner distributed over the central layer 17, which define an emergency cooling channel 6 between the central layer 17 and the housing sidewall 12 of a battery cell 3. On both sides of the device 4, sealing elements 18 are arranged. In the event of damage, the sealing elements 18 are to ensure the largest possible volume flow of cooling medium through the emergency cooling channel 6.

The two devices 4 shown below have a meandering central layer which alternately defines an emergency cooling channel 6.

The devices 4 can be of metal, ceramic or high-temperature resistant plastic materials. With these materials it is ensured that the emergency cooling channels 6 are present even when the battery cell 3 undergoes substantial deformation.

Soft materials, such as elastomers, in particular silicone materials, have the advantage that these dimensional alterations of the battery cells 3 during ageing and during charging/discharging operations, can be compensated for in part and thus prevent excessive compression of the battery cells 3. It is also conceivable for the central layer 17 to consist of a ceramic foil, wherein the spacer elements and the sealing elements consist of an elastomeric material.

The middle device 4 and the device 4 arranged below include closed emergency cooling channels 6. These embodiments of the device 4 are particularly rugged and resistant against substantially deforming battery cells 3. The device 4 can include common emergency cooling channels 6 (middle drawing) or separate emergency cooling channels 6 (drawing below that).

The two bottom drawings show further developments of the middle devices 4, wherein the devices 4 include local melting regions 19 so that cooling medium can be directly applied to the housing sidewall 12 of an adjacent battery cell 3.

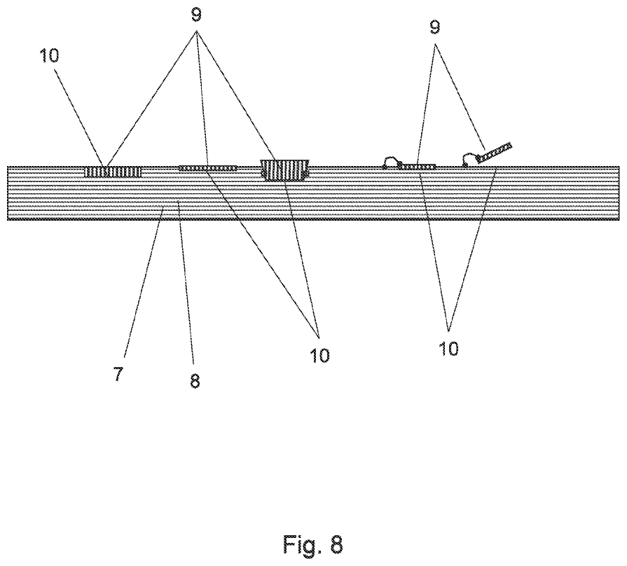

FIG. 8 shows various embodiments of closure elements 9 which open in the event of damage and can establish a flow-conducting communication between cooling channel 8 and emergency cooling channel 6. The closure elements 9 shown in FIG. 8 can be variously provided on any of the above-described cooling apparatus 7. Herein the closure element 9 can be a separate component, which is introduced into an opening of the cooling channel 8. The closure element 9 can be formed as a molded part, in particular a plug.

Furthermore, the closure element 9 can be formed as a foil, which is applied to an opening of the cooling channel 8 in an adhesive manner. Furthermore, it is conceivable that a closure element 9 can include an opening device, which can be thermally activated and which establishes a flow-conducting communication between cooling channel 8 and emergency cooling channel 6 when a predetermined temperature is exceeded. Such a closure element 9 can be implemented, for example, by means of a shape-memory alloy.

If the closure element 9 is formed as a foil, the latter can be arranged across an opening or recess in the sidewall of the cooling channel 8. Use of a foil is advantageous in that it can be made very thin and can ensure surface-contact between the cooling channel 8 and the battery cell 3. Thermoplastic materials, such as polyolefins, polyesters, polyamides or polyvinyl alcohols can be used as the foil material, in particular. In particular, when copolymers are used, their melting point can be reduced. Foil materials which are stable with respect to the cooling medium over long periods of time at temperatures of up to 80° C., and which quickly melt at temperatures above 120° C. and establish a communication between cooling channel 8 and emergency cooling channel 6 are advantageous.

Metal-based foils are also conceivable, for example tin-based alloys. A Sn99Cu1 binary alloy, for example, has a melting point at about 200° C. Metal foils have the advantage that they have better thermal conductivity which improves heat transfer during normal operation and results in accelerated melting in the event of damage.

Mechanical closure elements 9 are preferably formed of thermoplastic materials or elastomers.

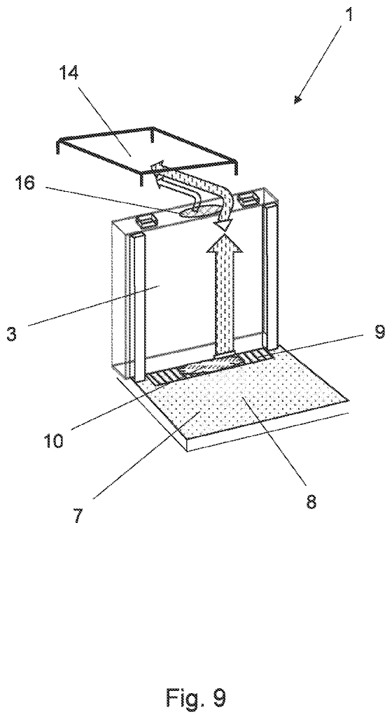

FIG. 9 shows the space 5 in the region of a battery cell 3 undergoing thermal runaway. The thermal runaway of the battery cell 3 results in a large amount of hot pollutant gases being discharged from the battery cell emergency opening 16. The closure element 9 is open and has exposed the emergency opening 10 so that cooling medium flows from the cooling channel 8 into the device 4. In the process, at least part of the cooling medium evaporates. In the region of the upper surface of the battery cell 3, the cooling medium is mixed with the pollutant gases emitted from the battery cell 3, the cooling medium thus reducing the temperature of the mixed fluid flow. Furthermore, the cooling medium reduces the flammability and the toxicity of the pollutant gases. It is also conceivable to discharge the gas flow from the cell module through a channel 14 in a conducted manner.

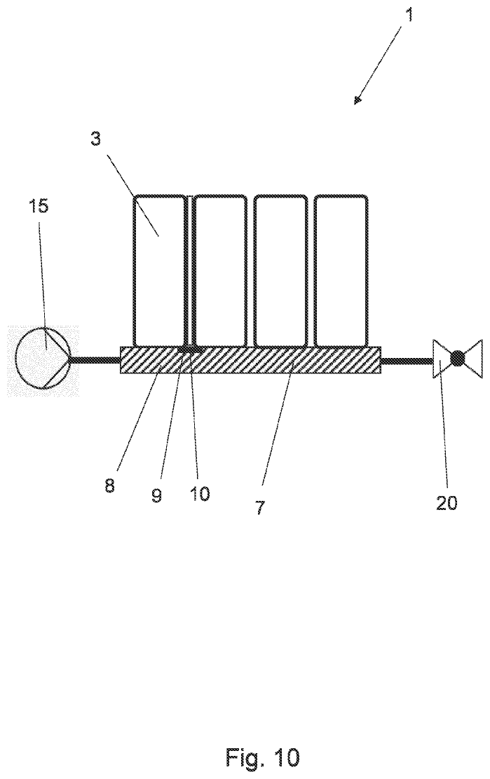

FIG. 10 shows an energy storage system 1, comprising four battery cells 3, which are situated atop a cooling apparatus 7. The device 4 and the closure element 9 are schematically shown between two of the battery cells 3. The flow of the cooling medium through the cooling apparatus 7 is caused by a pump 15. Downstream, a switchable shut-off valve 20 is arranged. During thermal runaway of a battery cell 3, the closure element 9 exposes the emergency opening 10 and cooling medium is applied to the device 4. In the present embodiment, in this situation, the pump 15 increases the cooling medium flow and the shut-off valve 20 is closed. This causes increased and channeled transport of the cooling medium through the device 4 and thus improved emergency cooling action.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: An energy storage system, comprising a housing in which a plurality of battery cells are arranged, wherein the plurality of battery cells are spaced with respect to each other by a device arranged between every two respective adjacent battery cells of the plurality of battery cells, so that a space is created therein, wherein at least one emergency cooling channel is associated with the space.

2: The energy storage system according to claim 1, comprising a cooling apparatus having at least one cooling channel, wherein the cooling channel is configured to be brought into a flow communication with the emergency cooling channel in the event of damage.

3: The energy storage system according to claim 2, wherein the cooling channel includes at least one closure element, which opens in the event of damage and establishes a flow-conducting communication between the cooling channel and the emergency cooling channel.

4: The energy storage system according to claim 1, wherein the device includes webs, which define the emergency cooling channels.

5: The energy storage system according to claim 1, wherein a sidewall of the emergency cooling channel is formed by a housing sidewall of an adjacent battery cell of the plurality of battery cells.

6: The energy storage system according to claim 1, wherein the emergency cooling channel is formed within the device.

7: The energy storage system according to claim 1, comprising at least two emergency cooling channels, wherein a first emergency cooling channel of the at least two emergency cooling channels is associated with one adjacent battery cell of the plurality of battery cells and a second emergency cooling channel of the at least two emergency cooling channels is associated with the another adjacent battery cell of the plurality of battery cells.

8: The energy storage system according to claim 1, wherein the device is formed of plastic, of metal or of ceramic.

9: The energy storage system according to claim 1, wherein the device is formed separately from the plurality of battery cells.

10: The energy storage system according to claim 1, wherein the emergency cooling channel is in communication with the environment on a side facing away from the cooling channel.

11: The energy storage system according to claim 3, wherein the closure element is configured to be thermally activated.

12: The energy storage system according to claim 3, wherein the closure element is formed as a molded part.

13: The energy storage system according to claim 12, wherein the closure element is formed as a foil or as a plug.

14: The energy storage system according to claim 1, wherein a cooling medium discharged from the emergency cooling channel on a side opposite the cooling channel is mixed with a pollutant gas discharged from one or more of the plurality of battery cells.
